(19) United States
(12) Patent Application Publication
(10) Pub. No.: US 2010/0082607 A1
(43) Pub. Date: Apr. 1, 2010

(54) SYSTEM AND METHOD FOR AGGREGATING A LIST OF TOP RANKED OBJECTS FROM RANKED COMBINATION ATTRIBUTE LISTS USING AN EARLY TERMINATION ALGORITHM

(75) Inventors: Kunal Punera, Mountain View, CA (US); Shanmugasundaram Ravikumar, Berkeley, CA (US); Torsten Suel, Mountain View, CA (US); Serguei Vassilvitskii, New York, NY (US)

Correspondence Address: Law Office of Robert Bolan, P.O. Box 36, Bellevue, WA, 98009, US

(73) Assignee: YAHOO! INC., Sunnyvale, CA (US)

(21) Appl. No.: 12/238,401

(22) Filed: Sep. 25, 2008

(51) Int. Cl. G06F 7/10; G06F 17/30

(52) U.S. Cl. 707/723; 707/737

(57) ABSTRACT

An improved system and method for aggregating a list of top ranked objects from ranked combination lists using an early termination algorithm is provided. Ranked lists of individual object attributes may be aggregated into ranked lists of combination object attributes. The ranked lists of object attributes, including ranked lists of individual object attributes as well as ranked lists of combination object attributes, may be scanned in parallel. A fixed number of top scoring objects may be stored in a results list of top ranked objects. An upper bound of best possible aggregation scores of unseen object in the ranked lists of object attributes may be computed to incorporate the extra information given by the combination lists of attributes. If the upper bound computed is less than the score of top scoring objects in the results list, then the top scoring objects in the results list may be output.

### FIELD OF THE INVENTION

The invention relates generally to computer systems, and more particularly to an improved system and method for aggregating a list of top ranked objects from ranked combination lists using an early termination algorithm.

### BACKGROUND OF THE INVENTION

There has been considerable past work on efficiently computing top objects by aggregating information from ranked lists of individual attributes of these objects. Efficient top-k aggregation plays a vital role in large-scale database and information retrieval systems. An important instance of this problem is query processing in search engines where k is small and the posting lists can be overwhelmingly long. One particularly well-studied approach to achieve efficiency in top-k aggregation includes early termination algorithms.

Early-termination is an attractive option to ensure efficiency in top-k aggregation, and such algorithms have been developed in both database and IR contexts. See, for example, R. Fagin, A. Lotem, and M. Naor, Optimal Aggregation Algorithms for Middleware, JCSS, 66(4):614-656, 2003; S. Nepal and M. V. Ramakrishna, Query Processing Issues in Image (Multimedia) Databases, in 15th ICDE, pages 22-29, 1999; U. Güntzer, W.-T. Balke, and W. Kiebling, Optimizing Multi-feature Queries for Image Databases, in 26th VLDB, pages 419-428, 2000; V. N. Anh, O. de Kretser, and A. Moffat, Vector-space Ranking with Effective Early Termination, In 24th SIGIR, pages 35-42, 2001; and V. N. Anh and A. Moffat, Compressed Inverted Files with Reduced Decoding Overheads, In 21st SIGIR, pages 290-297, 1998.

Two particularly interesting early termination algorithms are the Threshold Algorithm (TA) and the No Random-access Algorithm (NRA) proposed by Fagin, Lotem, and Naor. See R. Fagin, A. Lotem, and M. Naor, Optimal Aggregation Algorithms for Middleware, JCSS, 66(4):614-656, 2003. The Threshold Algorithm assumes random access capabilities to the list while the No Random-access Algorithm assumes only sequential access. These algorithms require aggregation functions to be monotone and proceed as follows. The input lists are scanned in parallel and the top k objects seen so far are stored. At each step, an upper bound on the best possible aggregated score of an object that is yet to be encountered is computed. If this upper bound is worse than the aggregated score of the k-th best object found so far, the algorithm stops. Note that the upper bound guarantees that the top k objects are correctly computed. However, these early termination algorithms fail to incorporate additional information such as combinations of attributes.

Another particularly well-studied approach to achieve efficiency in top-k aggregation includes pre-aggregation of some of the input lists. The use of combinations of attributes or pairs of terms to improve query processing has been addressed in several papers. See, for example, Long and Suel, Three-level Caching for Efficient Query Processing in Large Web Search Engines, In 14th WWW, pages 257-266, 2005. Long and Suel consider a three-level caching scheme for improving search engine performance, where the intermediate level is tasked to exploit frequently occurring pairs of terms by caching intersections or projections of the corresponding inverted lists. Unfortunately, incorporating additional information from using combinations of attributes has not been developed in early termination algorithms to achieve efficiency in top-k aggregation.

G. Das, D. Gunopulos, N. Koudas, and D. Tsirogiannis, Answering Top-k Queries Using Views, in 32nd VLDB, pages 451-462, 2006, consider the problem of answering top-k queries using views, where a view is a materialized version of a list that ranks values according to a positive linear combination of a subset of attributes of a relation. Their work relies on generic LP solvers and fail to provide combinatorial algorithms for the problem.

What is needed is a way of using additional information from combinations of attributes in early termination algorithms to achieve efficiency in top-k aggregation. Such a system and method should be able to return the top k results for application where the posting lists can be overwhelmingly long.

### SUMMARY OF THE INVENTION

The present invention provides a system and method for aggregating a list of top ranked objects from ranked combination lists using an early termination algorithm. Ranked lists of individual object attributes may be aggregated into ranked lists of combination object attributes. The ranked lists of object attributes, including ranked lists of individual object attributes as well as ranked lists of combination object attributes, may be scanned in parallel. A fixed number of top scoring objects may be stored in a results list of top ranked objects. An upper bound of best possible aggregation scores of unseen object in the ranked lists of object attributes may be computed to incorporate the extra information given by the combination lists of attributes. If the upper bound computed is less than the score of top scoring objects in the results list, then the top scoring objects in the results list may be output.

In one embodiment for aggregating a list of top ranked objects from ranked combination lists using a generalized Threshold Algorithm for early termination, a list may be selected in round robin order from the ranked lists of individual attributes and the ranked combination lists of multiple attributes. The next score for an object may be read from the list, and the scores for the object may be retrieved from each of the other ranked lists. An upper bound threshold for unseen objects in the ranked lists may be computed by a mathematical program such as a linear program or an approximation program. If the upper bound threshold computed for unseen objects in the ranked lists of object attributes is less than the lowest score of an object in the results list, then the results list of top ranked objects from ranked combination lists may be output.

In another embodiment for aggregating a list of top ranked objects from ranked combination lists using a generalized No Random-access Algorithm for early termination, a list may be selected in round robin order from the ranked lists of individual attributes and the ranked combination lists of multiple attributes. The next score for an object may be read from the list. The best possible score and the worst possible score may be computed for each object seen from the ranked lists of object attributes. If the best possible score for every object seen that is not in the ranked list of results is greater than a fixed number of largest worst scores computed for every object seen, then the results list of top ranked objects from ranked combination lists may be output.

The present invention may be used by many applications for aggregating a list of top ranked objects from ranked combination lists using an early termination algorithm. For example, information retrieval applications may use the present invention to output the top k most relevant documents given a multi-term query. In this case, the documents are the objects and the attribute lists are the posting lists for terms sorted by a relevance score. The relevance of a document for a multi-term query is defined to be an aggregation of the relevance scores for individual terms. Or, web search engines may use the present invention to find the top k web pages ranked according to an aggregation function to combine relevance scores of posting lists for terms. Or a database middleware system may use the present invention, given a set of objects and lists of object attributes ordered by attribute score, to find the top k objects ranked according to an aggregation function to combine attribute scores. For any of these applications, the present invention may aggregate a list of top ranked objects from ranked combination lists using an early termination algorithm.

Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for crawl ordering of a web crawler by impact upon search results of a search engine, in accordance with an aspect of the present invention;

FIG. 3 is a flowchart generally representing the steps undertaken in one embodiment for crawl ordering of a web crawler by impact upon search results of a search engine, in accordance with an aspect of the present invention;

FIG. 4 is a flowchart generally representing the steps undertaken in one embodiment for estimating the impact of uncrawled web pages for needy queries of a workload using content-independent features, in accordance with an aspect of the present invention; and

FIG. 5 is a flowchart generally representing the steps undertaken in one embodiment for determining an ordering of web pages to fetch using a query-based estimate and a query-independent estimate of the impact of fetching the web pages on search query results, in accordance with an aspect of the present invention.

### DETAILED DESCRIPTION

### Exemplary Operating Environment

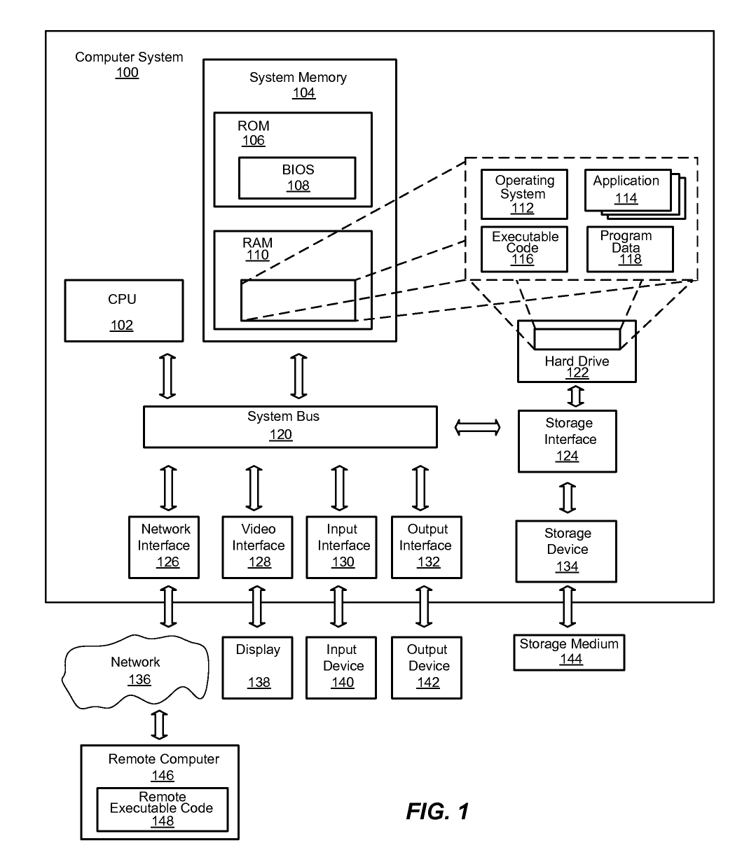

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used.

Aggregating a List of Top Ranked Objects from Ranked Combination Attribute Lists Using an Early Termination Algorithm

The present invention is generally directed towards a system and method for aggregating a list of top ranked objects from ranked combination lists using an early termination algorithm. Ranked lists of individual object attributes may be aggregated into ranked lists of combination object attributes. The ranked lists of object attributes, including ranked lists of individual object attributes as well as ranked lists of combination object attributes, may be scanned in parallel. A fixed number of top scoring objects may be stored in a results list of top ranked objects. An upper bound of best possible aggregation scores of unseen object in the ranked lists of object attributes may be computed to incorporate the extra information given by the combination lists of attributes. If the upper bound computed is less than the score of top scoring objects in the results list, then the top scoring objects in the results list may be output.

As will be seen, the ranked lists of combinations of object attributes help the early termination algorithms discover new objects. For example, an object may be far down in lists Lᵢ and Lⱼ, but be near the top in list L_{i,j}. Additionally, the ranked lists of combinations of object attributes improve the bounds computed on the unseen elements. As will be understood, the various block diagrams, flow charts and scenarios described herein are only examples, and there are many other scenarios to which the present invention will apply.

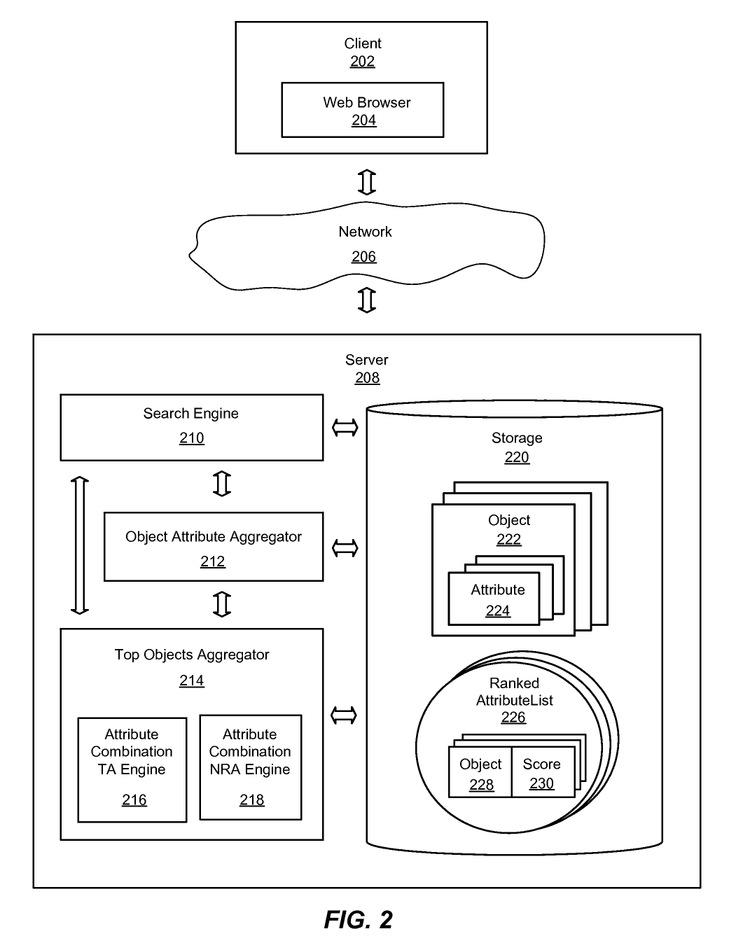

Turning to FIG. 2 of the drawings, there is shown a block diagram generally representing an exemplary architecture of system components for aggregating a list of top ranked objects from ranked combination lists using an early termination algorithm. Those skilled in the art will appreciate that the functionality implemented within the blocks illustrated in the diagram may be implemented as separate components or the functionality of several or all of the blocks may be implemented within a single component. For example, the functionality for the object attribute aggregator 212 may be included in the same component as the top objects aggregator 214, or the functionality of the object attribute aggregator 212 may be implemented as a separate component from the top objects aggregator 214 as shown. Moreover, those skilled in the art will appreciate that the functionality implemented within the blocks illustrated in the diagram may be executed on a single computer or distributed across a plurality of computers for execution.

In various embodiments, a client computer 202 may be operably coupled to one or more servers 208 by a network 206. The client computer 202 may be a computer such as computer system 100 of FIG. 1. The network 206 may be any type of network such as a local area network (LAN), a wide area network (WAN), or other type of network. A web browser 204 may execute on the client computer 202 and may include functionality for receiving a search request which may be input by a user entering a query. The web browser 204 may include functionality for receiving a query entered by a user and for sending a query request to a server to obtain a list of search results. In general, the web browser 204 may be any type of interpreted or executable software code such as a kernel component, an application program, a script, a linked library, an object with methods, and so forth.

The server 208 may be any type of computer system or computing device such as computer system 100 of FIG. 1. In general, the server 208 may provide services for query processing and may include a search engine 210 for providing a list of documents as search results, an object attribute aggregator 212 for aggregating ranked lists of singleton object attributes into lists of combination object attributes, and a top objects aggregator 214 for aggregating a list of top ranked objects from ranked combination lists using an early termination algorithm. The top objects aggregator 214 may include an attribute combination threshold algorithm (TA) engine 216 for aggregating a list of top ranked objects from ranked combination lists using a generalized Threshold Algorithm and an attribute combination No Random Access Algorithm (NRA) engine 218 for aggregating a list of top ranked objects from ranked combination lists using a generalized No Random Access Algorithm. Each of these modules may also be any type of executable software code such as a kernel component, an application program, a linked library, an object with methods, or other type of executable software code.

The server 208 may be operably coupled to computer-readable storage such as storage 220 that may include objects 222 with attributes 224 and ranked attribute lists 226 that include objects 228 with a score 230. In an embodiment for query processing, the objects may represent web pages and the attributes may represent keywords of a query. In this case, a search engine may combine information from several different rankings of web pages to obtain the top k web-pages to answer user queries.

There may be many applications which may use the present invention for aggregating a list of top ranked objects from ranked combination lists using an early termination algorithm. In general, information retrieval applications may use the present invention to output the top k most relevant documents given a multi-term query. In this case, the documents are the objects and the attribute lists are the posting lists for terms. Within each posting list for a term, the documents that contain the term are sorted by a relevance score. The relevance of a document for a multi-term query is defined to be an aggregation of the relevance scores for individual terms. For instance, web search engines may use the present invention to find the top k web pages ranked according to an aggregation function to combine relevance scores of posting lists for terms. Typically, the top k web pages desired is small and the posting lists can be overwhelmingly long. Or a database middleware system may use the present invention, given a set of objects and lists of object attributes ordered by attribute score, to find the top k objects ranked according to an aggregation function to combine attribute scores. For any of these applications, the present invention may aggregate a list of top ranked objects from ranked combination lists using an early termination algorithm.

In the classic scenario for database middleware, the database D may include a set of objects {R₁, . . . ,Rₙ} where each object Rᵢ has m different scores which may also be referred to as parameters (x₁, . . . ,xₘ). The database may be considered to represent m sorted lists, L₁, . . . ,Lₘ, and each element in list Lᵢ has a pair (R,xᵢ) where xᵢ is the i-th field of R. The lists are stored in decreasing sorted order by xᵢ.

Consider list Lᵢ_{₁}, . . . ,ᵢ_{ₛ} to denote combination lists that are composed of the combination of lists Lᵢ_{₁},Lᵢ_{₂}, . . . ,Lᵢ_{ₛ}. The early termination algorithms presented may work in the limited information case, where each element of Lᵢ_{₁}, . . . ,ᵢ_{ₛ} is of the form (R,tᵢ_{₁}, . . . ,iₛ(sᵢ_{₁}, . . . ,xᵢ_{ₛ})) and tᵢ_{₁}, . . . ,ᵢ_{ₛ} is a partial aggregation function. In this case, the individual scores of R may not be learned but the partially aggregate score may instead be learned. The early termination algorithms presented may also work in the full information case where in addition to knowing the partially aggregated score, the individual scores xᵢ_{₁} through xᵢ_{ₛ} of R may be learned.

Also consider the aggregation function t(•) used in retrieving the top k elements to be monotone, that is: t(x₁, . . . ,xₘ)≦t(x′₁, . . . ,x′ₘ) whenever xᵢ≦x′ᵢ for every i. In the limited information case, t may be further limited by belonging to a family of symmetric decomposable functions. Consider ρ={P₁, . . . ,Pₖ} to be a partition of {1,2, . . . ,m}. For example, if m=6, then a possible partition is ρ={{1,4,6},{2,5},{3}}. The threshold function t is considered ρ-decomposable, if there exists a function t′, and functions f^{P}^{₁}, f^{P}^{₂}, . . . ,f^{P}^{ₖ} such that

t(x₁, . . . ,xₘ)=t′(f^{P}^{₁}({xᵢ|i ∈ P₁}), . . . ,f^{P}^{ₖ}({xᵢ|i ∈ Pₖ})).

In the example above, there may exist functions f^{1,4,5},f^{2,5},f³ and a function t′ such that t(x₁,x₂,x₃,x₄,x₅,x₆)=t′(f^{1,4,6}(x₁,x₄,x₆),f^{2,5}(x₂,x₅),f³(x₃)). There may be many functions that occur in practice which are decomposable. For example, if t=min(•), max(•) or sum(•), the decomposition may be t′=f=t.

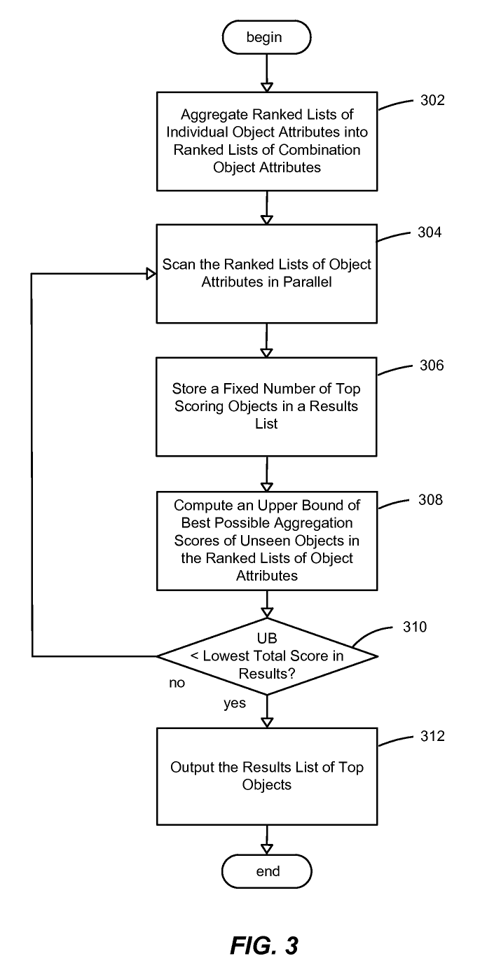

The overall process of aggregating a list of top ranked objects may be represented by FIG. 3 which presents a flowchart for generally representing the steps undertaken in one embodiment for aggregating a list of top ranked objects from ranked combination lists of object attributes using an early termination algorithm. At step 302, ranked lists of individual object attributes may be aggregated into ranked lists of combination object attributes. In an embodiment, some of the ranked lists of individual object attributes may be aggregated to produce new and possibly shorter lists. For example, posting lists for pairs of terms may be constructed from their individual posting lists. In an implementation, the posting list for a term pair may include the documents that contain both the individual terms along with their aggregated relevance score. The posting list for a pair of terms thus represents a combination of object attributes resulting from intersections of lists with individual terms. In various embodiments, the combination lists may be pre-computed.

The ranked lists of object attributes may be scanned in parallel at step 304. In an embodiment, the ranked lists of object attributes may include ranked lists of individual object attributes as well as ranked lists of combination object attributes. At step 306, a fixed number of top scoring objects may be stored in a results list of top ranked objects.

An upper bound of best possible aggregation scores of unseen object in the ranked lists of object attributes may be computed at step 308. In a generalized early termination algorithm, an upper bound on the aggregated score of yet unseen objects may be computed to incorporate the extra information given by the combination lists of attributes. In various embodiments, the upper bound may be computed by a mathematical program. For simple decomposable aggregation functions such as addition, this simplifies to a linear program that can be solved in polynomial time. Addition is a natural aggregation function that is of interest in particular for information retrieval, where the relevance score of a document to a multi-term query is the sum of the relevance scores of the document to each of the terms in the query. While the linear program gives an optimum upper bound, it can be expensive to solve, especially if the number of lists is large. In an embodiment, an approximation algorithm may be used that computes a threshold within a factor of two of the optimum upper bound. Importantly, this approximation algorithm also extends to combination lists constructed from more than two lists.

At step 310, it may be determined whether the upper bound computed is less than the total score of top scoring objects stored in the results list. If the upper bound computed is not less than the total score of top scoring objects in the results list, then processing may continue at step 304 and the ranked lists of object attributes may continue to be scanned in parallel. If the upper bound computed is less than the total score of top scoring objects in the results list, then the top scoring objects in the results list may be output at step 312 and processing may be finished.

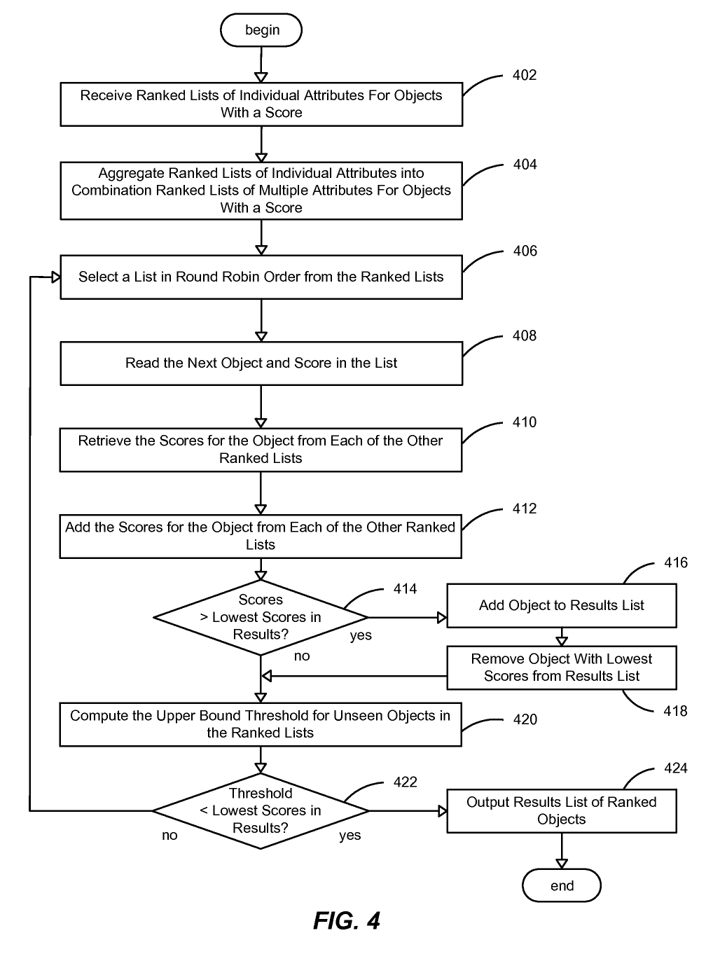

FIG. 4 presents a flowchart for generally representing the steps undertaken in one embodiment for aggregating a list of top ranked objects from ranked combination lists using a generalized Threshold Algorithm for early termination.

At step 402, ranked lists of individual attributes may be received for objects with a score. The ranked lists of individual attributes may be aggregated into ranked combination lists of multiple attributes with a score for objects at step 404. At step 406, a list may be selected in round robin order from the ranked lists of individual attributes and the ranked combination lists of multiple attributes. At step 408, the next score for an object may be read from the list. And at step 410, the scores for the object may be retrieved from each of the other ranked lists. At step 412, the scores for the object retrieved from the ranked lists may be added.

It should be noted that the object may be added to the results list if there are less than a fixed number of objects in the results list. Assuming there are a fixed number of objects in the results list, it may then be determined whether the sum of the scores for the object is greater than the lowest score for an object in the results list at step 414. If so, then the object may be added to the results list at step 416 and the object with the lowest score may be removed from the results list at step 418. If it may be determined that the sum of the scores for the object is not greater than the lowest score for an object in the results list at step 414, then the upper bound threshold for unseen objects in the ranked lists may be computed at step 420.

A common problem in the design of the early termination condition for top-k algorithms, and in particular, TA and NRA, is to obtain an upper bound on the aggregated score for elements not yet seen. Consider that the score of each parameter i may be bounded by xᵢ. Then, for every element U=(x₁,x₂, . . . ,xₘ), xᵢ≦xᵢ, and t(U)≦t(x₁,x₂, . . . ,xₘ) given the monotonicity of the aggregation function. Where extra information may be known for the aggregated score of some of the elements, the upper bound may be expressed as a mathematical program. Consider a case, for instance, where m=3 and the aggregation function t is sum of all elements, such that t(x₁,x₂,x₃)=x₁+x₂+x₃. If the bounds of x₁,x₂,x₃ may be known, then an easy bound on t is x₁+x₂+x₃. If, in addition, it is known that x₁+x₂≦x_{1,2}, t may also be bounded by x_{1,2}+x₃. Suppose that the values of x_{2,3} and x_{1,3} may also be known, then t may be bounded by:

$$t ( {x}_{1} , {x}_{2} , {x}_{3} ) \leq \frac{{\underline{x}}_{1 , 2} + {\underline{x}}_{2 , 3} + {\underline{x}}_{1 , 3}}{2} .$$

Given these five possible bounds on t, the minimum may be computed over all of them by

$$t \leq min \{ \begin{matrix}{\underline{x}}_{1} + {\underline{x}}_{2} + {\underline{x}}_{3} \\ {\underline{x}}_{1 , 2} + {\underline{x}}_{3} \\ {\underline{x}}_{1 , 3} + {\underline{x}}_{2} \\ {\underline{x}}_{2 , 3} + {\underline{x}}_{1} \\ 1 / 2 ( {x}_{1 , 2} + {x}_{1 , 3} + {x}_{2 , 3} ) .\end{matrix}$$

This minimum may be formulated as a linear program: minimize x₁+x₂+x₃, subject to xᵢ≦xᵢ, ∀i and xᵢ+xⱼ≦x_{i,j}, ∀i,j.

And, more generally, given the decomposition of the aggregation function t with the resulting functions f^{P} and t′, as above, and upper bounds x_{P}, the optimization may be expressed as a mathematical program: maximize: τ=t′(f^{P}^{₁}({xᵢ|i ∈ P₁}), . . . , subject to f^{P}({xⱼ:J ∈ P})≦x_{P}, ∀P.

For arbitrary functions f^{P}, this may be a complicated optimization problem. However, f may be the addition function in the context of information retrieval where the relevance of a document to a multi-term query is the sum of the relevance of the document to each of the terms in the query. In this case, t is also the addition function, and each list is a combination of at most two elements. So, t(x₁, . . . ,xₘ)=x₁+ . . . +xₘ, and a list Lᵢⱼ has scores of xᵢ+xⱼ. The mathematical program then simplifies to minimize x₁+x₂+x₃, subject to xᵢ≦xᵢ, ∀i and xᵢ+xⱼ≦x_{i,j}, ∀i,j. This linear program can be expensive to solve where the number of lists is large. To handle this, an approximation algorithm may be used that computes a threshold within a factor of two of the optimum upper bound. This approximation algorithm also extends to combination lists that involve more than two lists.

Values yᵢ and yᵢⱼ may be initially stored which will represent our best upper bounds for the values of xᵢ and xᵢⱼ. The next step may assign yᵢ=xᵢ and yᵢⱼ=xᵢⱼ. Considering each of the paired constraints, yᵢ+yⱼ≦yᵢⱼ, yᵢ≦min(yᵢ₁,yᵢ₂, . . . ,yᵢₘ) since all of the values y are positive. The yᵢ's may be reduced until yᵢ≦min(yᵢ₁,yᵢ₂, . . . ,yᵢₘ) is satisfied for all i and j. Since yᵢⱼ is the bound on the sum of xᵢ+xⱼ and yᵢ is a bound on the value of xᵢ, then yᵢⱼ≦yᵢ+yⱼ. The yᵢⱼ's may be reduced until yᵢⱼ≦yᵢ+yⱼ is satisfied for all i and j. By iteratively reducing yᵢ's until yᵢ≦min(yᵢ₁,yᵢ₂, . . . ,yᵢₘ) is satisfied and yᵢⱼ's until yᵢⱼ≦yᵢ+yⱼ is satisfied for all i and j, a set of values y may be found that satisfy these conditions.

Returning to step 422 of FIG. 4, it may be determined whether the upper bound threshold computed for unseen objects in the ranked lists of object attributes is less than the lowest score of an object in the results list. If not, then processing may continue at step 406 where a list may be selected in round robin order from the ranked lists of individual attributes and the ranked combination lists of multiple attributes. Otherwise if it may be determined at step 422 that the upper bound threshold computed for unseen objects in the ranked list is less than the lowest score of an object in the results list, then the results list of ranked objects may be output at step 424 and processing may be finished for aggregating a list of top ranked objects from ranked combination lists using a generalized Threshold Algorithm for early termination.

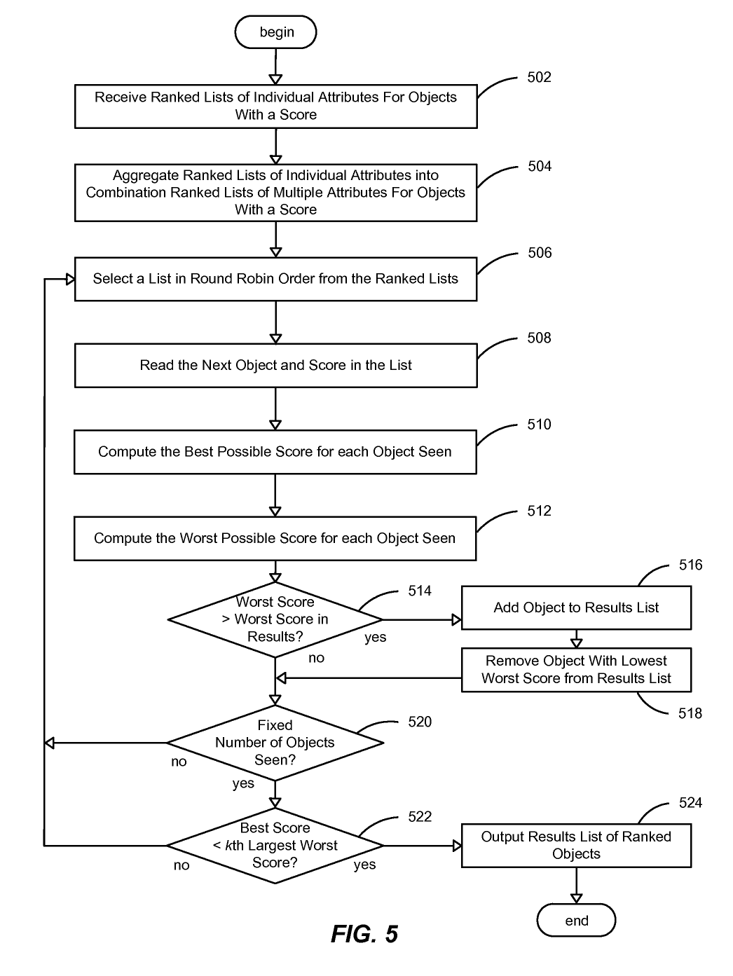

FIG. 5 presents a flowchart for generally representing the steps undertaken in one embodiment for aggregating a list of top ranked objects from ranked combination lists using a generalized No Random-access Algorithm for early termination. Unlike the generalized TA algorithm, the generalized NRA algorithm does not make any random accesses throughout the ranked lists of object attributes but instead accesses object attributes through sequential list access. At step 502, ranked lists of individual attributes may be received for objects with a score. The ranked lists of individual attributes may be aggregated into ranked combination lists of multiple attributes with a score for objects at step 504. At step 506, a list may be selected in round robin order from the ranked lists of individual attributes and the ranked combination lists of multiple attributes.

At step 508, the next score for an object may be read from the list. And at step 510, the best possible score may be computed for each object seen from the ranked lists of object attributes. For instance, the upper bound for t(R) may be expressed as a mathematical program, where N may denote the set of variables that have been revealed, such as N={1,3,6}, that minimizes t(y₁, . . . ,yₘ), subject to: yᵢ=xᵢ for i ∈ N, yᵢ≦xᵢ for i ∉ N, and f^{P}({yⱼ:j ∈ P})≦x_{P}, ∀P [symbol] N.

At step 512, the worst possible score may be computed for each object seen from the ranked lists of object attributes. By substituting the value 0 for the objects yet unseen so that t(x₁,0,x₃,0,0,x₆), the lower bound for t(R) may be expressed as a mathematical program, where N may denote the set of variables that have been revealed, such as N={1,3,6}, that minimizes t(y₁, . . . ,yₘ), subject to: yᵢ=xᵢ for i ∈ N, yᵢ≦xᵢ for i ∉ N, and f^{P}({yⱼ:j ∈ P})≦x_{P}, ∀P [symbol] N.

It should be noted that the object may be added to the results list if there are less than a fixed number of objects in the results list. Assuming there are a fixed number of objects in the results list, it may then be determined whether the worst possible score for the object is greater than the lowest score for an object in the results list at step 514. If so, then the object may be added to the results list at step 516 and the object with the lowest score may be removed from the results list at step 518.

If it may be determined that the worst possible score for the object is not greater than the lowest score for an object in the results list at step 514, then it may be determined whether a fixed number of objects have been read from the ranked lists of object attributes at step 520. If it is determined that there have not been a fixed number of objects read from the ranked lists of object attributes, then processing may continue at step 506 where a list may be selected in round robin order from the ranked lists. If it is determined that there have been a fixed number of objects read from the ranked lists of object attributes, then it may be determined at step 522 whether the best score for every object seen that is not in the ranked list of results is less than the fixed number of largest worst scores computed for every object seen. Thus the generalized NRA algorithm may halt when at least k objects have been seen and for every object U that is not in the top k, B(U)<M, where B(U) is upper bound on the object score for U, and M is the kth largest worst score with ties broken in favor of higher best scores.

If the best score for every object seen that is not in the ranked list of results is not greater than the fixed number of largest worst scores computed for every object seen, then processing may continue at step 506 where a list may be selected in round robin order from the ranked lists. Otherwise, if it may be determined at step 522 that the best score for every object seen that is not in the ranked list of results is greater than the fixed number of largest worst scores computed for every object seen, then the results list of ranked objects may be output at step 524 and processing may be finished for aggregating a list of top ranked objects from ranked combination lists using a generalized No Random-access Algorithm for early termination.

Thus the present invention may provide generalizations of the TA and NRA algorithms where some pre-aggregated ranked lists of combination object attributes are available in addition to ranked lists of singleton object attributes. Importantly, the generalizations compute appropriate upper and lower bounds using a mathematical program to incorporate the additional information available for combinations of object attributes. In the case of the addition aggregation function, a matching-based algorithm may be used for pairwise intersections of object attributes, and a linear program that can be approximated may be used for intersections of object attributes over a larger number of lists. Moreover, an exact combinatorial algorithm based on minimum cost perfect matching may be used for pairwise intersections of object attributes. The intersections of object attributes improve the performance of retrieval algorithms in the following ways. First, the ranked lists of combinations of object attributes help the algorithm discover new objects. For example, an object may be far down in lists Lᵢ and Lⱼ, but be near the top in list L_{i,j}. Secondly, the ranked lists of combinations of object attributes improve the bounds on the unseen elements as computed by the mathematical program.

As can be seen from the foregoing detailed description, the present invention provides an improved system and method for aggregating a list of top ranked objects from ranked combination lists using an early termination algorithm Ranked lists of individual object attributes may be aggregated into ranked lists of combination object attributes. The ranked lists of object attributes, including ranked lists of individual object attributes as well as ranked lists of combination object attributes, may be scanned in parallel. A fixed number of top scoring objects may be stored in a results list of top ranked objects. An upper bound of best possible aggregation scores of unseen object in the ranked lists of object attributes may be computed to incorporate the extra information given by the combination lists of attributes. If the upper bound computed is less than the score of top scoring objects in the results list, then the top scoring objects in the results list may be output. As a result, the system and method provide significant advantages and benefits needed in contemporary computing, and more particularly in online search applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for aggregating a list of ranked objects, comprising:
a top objects aggregator for aggregating a list of top ranked objects from a plurality of ranked lists of a combination of object attributes for a plurality of objects; and
a storage operably coupled to the top objects aggregator for storing the plurality of ranked lists of the combination of object attributes for the plurality of objects.

2. The system of claim 1 further comprising an attribute combination Threshold Algorithm engine for aggregating the list of top ranked objects from the plurality of ranked lists of the combination of object attributes for the plurality of objects.

3. The system of claim 1 further comprising an attribute combination No Random-access Algorithm engine for aggregating the list of top ranked objects from the plurality of ranked lists of the combination of object attributes for the plurality of objects.

4. The system of claim 1 further comprising an object attribute aggregator operably coupled to the top objects aggregator for constructing the ranked list of the combination of object attributes for the plurality of objects from ranked lists of singleton object attributes.

5. A computer-implemented method for aggregating a list of ranked objects, comprising:
obtaining an object with a score from a ranked list of a combination of object attributes for a plurality of objects;
computing a best possible score for each of a plurality of objects obtained from a plurality of ranked lists of object attributes that include the ranked list of the combination of object attributes;
computing an upper bound threshold for unseen objects in the plurality of ranked lists of object attributes that include the ranked list of the combination of object attributes;
determining whether the upper bound threshold for unseen objects in the plurality of ranked lists of object attributes is lower than a lowest score for a plurality of objects in a ranked results list; and
outputting the plurality of objects in the ranked results list when it is determined that the upper bound threshold for unseen objects in the plurality of ranked lists of object attributes is lower than a lowest score for the plurality of objects in the ranked results list.

6. The method of claim 5 further comprising aggregating at least two ranked lists of singleton object attributes to construct the ranked list of the combination of object attributes for the plurality of objects.

7. The method of claim 5 further comprising scanning the plurality of ranked lists of object attributes that include the ranked list of the combination of object attributes.

8. The method of claim 5 further comprising storing a fixed number of the plurality of objects with top scores in the ranked results list.

9. The method of claim 5 further comprising receiving the plurality of ranked lists of object attributes that includes the ranked list of the combination of object attributes.

10. The method of claim 5 wherein obtaining the object with the score from the ranked list of the combination of object attributes for the plurality of objects comprises selecting a list in round robin order from the plurality of ranked lists of object attributes that include the ranked list of the combination of object attributes and reading a next unread object and score from the selected list.

11. The method of claim 5 wherein computing the best possible score for each of the plurality of objects obtained from the plurality of ranked lists of object attributes that include the ranked list of the combination of object attributes comprises retrieving a plurality of unseen scores for the object with the score from the ranked list of the combination of object attributes for the plurality of objects and adding the unseen scores to the seen scores for the object.

12. The method of claim 11 further comprising:
determining whether the score for the object is greater than the lowest score in the results list;
adding the object to the results list when it is determined that the score for the object is greater than the lowest score in the results list; and
removing the object with the lowest score in the results list when it is determined that the score for the object is greater than the lowest score in the results list.

13. The method of claim 5 wherein computing the upper bound threshold for unseen objects in the plurality of ranked lists of object attributes that include the ranked list of the combination of object attributes comprises computing a minimum of an aggregation function for inequalities using a linear program.

14. The method of claim 5 wherein computing the upper bound threshold for unseen objects in the plurality of ranked lists of object attributes that include the ranked list of the combination of object attributes comprises using an approximation algorithm to compute the upper bound threshold within a factor of two of an optimum upper bound threshold.

15. A computer-readable medium having computer-executable instructions for performing the method of claim 5.

16. A computer-implemented method for aggregating a list of ranked objects, comprising:
obtaining an object with a score from a ranked list of a combination of object attributes for a plurality of objects;
computing a best possible score for each of a plurality of objects obtained from a plurality of ranked lists of object attributes that include the ranked list of the combination of object attributes;
computing a worst possible score for each of the plurality of objects obtained from the plurality of ranked lists of object attributes that include the ranked list of the combination of object attributes;
determining whether the best possible score for each of the plurality of objects obtained from the plurality of ranked lists of object attributes that are not in a ranked results list is less than a fixed number of largest worst possible scores for each of the plurality of objects obtained from the plurality of ranked lists of object attributes; and
outputting the plurality of objects in the ranked results list when it is determined that the best possible score for each of the plurality of objects obtained from the plurality of ranked lists of object attributes that are not in a ranked results list is less than a fixed number of largest worst possible scores for each of the plurality of objects obtained from the plurality of ranked lists of object attributes.

17. The computer system of claim 16 further comprising aggregating at least two ranked lists of singleton object attributes to construct the ranked list of the combination of object attributes for the plurality of objects.

18. The computer system of claim 16 further comprising determining whether the worst possible score for each of the plurality of objects obtained from the plurality of ranked lists of object attributes is greater than the lowest score for the plurality of objects in the ranked results list.

19. The computer system of claim 18 further comprising:
adding an object obtained from the plurality of ranked lists of object attributes when it is determined that the worst possible score for the object is greater than the lowest score for the plurality of objects in the ranked results list; and
removing the object with the lowest score in the results list when it is determined that the worst possible score for the object is greater than the lowest score for the plurality of objects in the ranked results list.

20. A computer-readable medium having computer-executable instructions for performing the method of claim 16.
